(19) United States
(12) Patent Application Publication
(10) Pub. No.: US 2025/0348443 A1
(43) Pub. Date: Nov. 13, 2025

(54) DEVICE CONTROL METHOD, MEMORY STORAGE DEVICE AND MEMORY CONTROL CIRCUIT UNIT

(71) Applicant: PHISON ELECTRONICS CORP., Miaoli (TW)

(72) Inventors: Yuwei Kuo, Hsinchu City (TW); Yun-You Lin, Kaohsiung City (TW); Chun Ming Liu, Taipei City (TW)

(73) Assignee: PHISON ELECTRONICS CORP., Miaoli (TW)

(21) Appl. No.: 18/677,920

(22) Filed: May 30, 2024

(30) Foreign Application Priority Data
May 10, 2024 (TW) 113117314

(51) Int. Cl. G06F 13/16; G06F 13/40

(52) U.S. Cl. CPC G06F 13/1668; G06F 13/1642; G06F 13/4022

(57) ABSTRACT

A device control method, a memory storage device and a memory control circuit unit are provided. The device control method includes: obtaining device status information of the memory storage device, and the device status information reflects whether the memory storage device is performing a default operation; and adjusting a connection interface standard used by a connection interface unit of the memory storage device from a first connection interface standard to a second connection interface standard according to the device status information, and the first connection interface standard is different from the second connection interface standard.

### CROSS-REFERENCE TO RELATED APPLICATION

This application claims the priority benefit of Taiwan application serial no. 113117314, filed on May 10, 2024. The entirety of the above-mentioned patent application is hereby incorporated by reference herein and made a part of this specification.

### BACKGROUND

### Technical Field

The disclosure relates to a memory control technology, and in particular relates to a device control method, a memory storage device, and a memory control circuit unit.

### Description of Related Art

The rapid growth of portable electronic devices such as mobile phones and laptops in recent years has led to a rapid increase in consumer demand for storage media. Since a rewritable non-volatile memory module (e.g. a flash memory) has the characteristics of data non-volatility, power saving, small size, and having no mechanical structure, it is very suitable for being built in a variety of portable electronic devices as exemplified above.

As technology advances, demands of users for data transfer rates between memory storage devices and host systems have progressively increased. Taking the peripheral component interconnect express (PCI Express) standard as an example, the supported data transfer rates have significantly increased from Gen 1 to Gen 5 of the PCI Express standard. However, the increase in data transfer rates between memory storage devices and host systems leads to adverse effects on the memory storage devices and host systems, including a rise in device temperature and an increase in power consumption. Excessive temperatures may trigger the thermal shutdown protection process of memory storage devices, thereby affecting the user experience. Furthermore, if either the memory storage device or the host system is unable to utilize high-speed transmission or does not require high-speed transmission, an excessively high-speed connection interface standard may result in a lower energy conversion rate, thereby reducing the performance per watt of the memory storage device.

### SUMMARY

A device control method, a memory storage device and a memory control circuit unit, which can improve the energy conversion rate of the memory storage device, are provided in the disclosure.

A device control method for a memory storage device is provided in an exemplary embodiment of the disclosure. The memory storage device includes a connection interface unit for coupling to a host system, and the device control method includes the following operation. Device status information of the memory storage device is obtained, in which the device status information reflects whether the memory storage device is performing a default operation. A connection interface standard used by a connection interface unit of the memory storage device is adjusted from a first connection interface standard to a second connection interface standard according to the device status information, in which the first connection interface standard is different from the second connection interface standard.

In an exemplary embodiment of the disclosure, the default operation includes at least one of a garbage collection operation, a wear leveling operation, a device self-test operation, and an error handle operation.

In an exemplary embodiment of the disclosure, adjusting the connection interface standard used by the connection interface unit of the memory storage device from the first connection interface standard to the second connection interface standard includes the following operation. In response to the memory storage device performing the default operation, an expected data transfer volume per unit time is generated between the memory storage device and the host system. The connection interface standard used by the connection interface unit of the memory storage device is adjusted from the first connection interface standard to the second connection interface standard according to the expected data transfer volume per unit time.

In an exemplary embodiment of the disclosure, generating the expected data transfer volume per unit time between the memory storage device and the host system includes the following operation. The expected data transfer volume per unit time corresponding to the default operation is obtained from a comparison table.

In an exemplary embodiment of the disclosure, the device status information further includes a current transfer rate of the memory storage device, and generating the expected data transfer volume per unit time between the memory storage device and the host system includes the following operation. The expected data transfer volume per unit time is obtained according to the current transfer rate based on the default operation.

In an exemplary embodiment of the disclosure, the device control method further includes the following operation. In response to completing the default operation, the connection interface standard used by the connection interface unit is restored from the second connection interface standard to the first connection interface standard.

In an exemplary embodiment of the disclosure, the device control method further includes the following operation. In response to completing the default operation, the connection interface standard used by the connection interface unit is adjusted from the second connection interface standard to a third connection interface standard according to a current temperature of the memory storage device and/or a number of pending commands. The third connection interface standard is different from the first connection interface standard and the second connection interface standard.

In an exemplary embodiment of the disclosure, the device control method further includes the following operation. A power status protocol is received from the host system. The power status protocol includes a default condition for adjusting the connection interface standard used by the connection interface unit and a specified connection interface standard corresponding to the default condition. In response to the default condition being met, the connection interface standard used by the connection interface unit is adjusted from the first connection interface standard to the specified connection interface standard, in which the first connection interface standard is different from the specified connection interface standard.

In an exemplary embodiment of the disclosure, the device control method further includes the following operation. A switching command and a specified connection interface standard are received from the host system. The connection interface standard used by the connection interface unit of the memory storage device is adjusted from the first connection interface standard to the specified connection interface standard based on the switching command, in which the first connection interface standard is different from the specified connection interface standard.

In an exemplary embodiment of the disclosure, the connection interface standard used by the connection interface unit includes at least two of N generations of PCI Express standards, in which N is a positive integer greater than 0.

In an exemplary embodiment of the disclosure, in response to the connection interface unit using the first connection interface standard, the memory storage device has a first data transfer volume per unit time upper limit. In response to the connection interface unit using the second connection interface standard, the memory storage device has a second data transfer volume per unit time upper limit. The first data transfer volume per unit time upper limit is different from the second data transfer volume per unit time upper limit.

An exemplary embodiment of the disclosure further provides a memory storage device, which includes a connection interface unit, a rewritable non-volatile memory module, and a memory control circuit unit. The connection interface unit is configured to couple to a host system. The memory control circuit unit is coupled to the connection interface unit and the rewritable non-volatile memory module, in which the memory control circuit unit is configured to perform the following operation. Device status information of the memory storage device is obtained, in which the device status information reflects whether the memory storage device is performing a default operation. A connection interface standard used by a connection interface unit of the memory storage device is adjusted from a first connection interface standard to a second connection interface standard according to the device status information, in which the first connection interface standard is different from the second connection interface standard.

In an exemplary embodiment of the disclosure, adjusting the connection interface standard used by the connection interface unit of the memory storage device from the first connection interface standard to the second connection interface standard by the memory control circuit unit includes the following operation. In response to the memory storage device performing the default operation, an expected data transfer volume per unit time is generated between the memory storage device and the host system. The connection interface standard used by the connection interface unit of the memory storage device is adjusted from the first connection interface standard to the second connection interface standard according to the expected data transfer volume per unit time.

In an exemplary embodiment of the disclosure, generating the expected data transfer volume per unit time between the memory storage device and the host system by the memory control circuit unit includes the following operation. The expected data transfer volume per unit time corresponding to the default operation is obtained from a comparison table.

In an exemplary embodiment of the disclosure, the device status information further includes a current transfer rate of the memory storage device, and generating the expected data transfer volume per unit time between the memory storage device and the host system by the memory control circuit unit includes the following operation. The expected data transfer volume per unit time is obtained according to the current transfer rate based on the default operation.

In an exemplary embodiment of the disclosure, the memory control circuit unit is further configured to perform the following operation. In response to completing the default operation, the connection interface standard used by the connection interface unit is restored from the second connection interface standard to the first connection interface standard.

In an exemplary embodiment of the disclosure, the memory control circuit unit is further configured to perform the following operation. In response to completing the default operation, the connection interface standard used by the connection interface unit is adjusted from the second connection interface standard to a third connection interface standard according to a current temperature of the memory storage device and/or a number of pending commands. The third connection interface standard is different from the first connection interface standard and the second connection interface standard.

In an exemplary embodiment of the disclosure, the memory control circuit unit is further configured to perform the following operation. A power status protocol is received from the host system. The power status protocol includes a default condition for adjusting the connection interface standard used by the connection interface unit and a specified connection interface standard corresponding to the default condition. In response to the default condition being met, the connection interface standard used by the connection interface unit is adjusted from the first connection interface standard to the specified connection interface standard, in which the first connection interface standard is different from the specified connection interface standard.

In an exemplary embodiment of the disclosure, the memory control circuit unit is further configured to perform the following operation. A switching command and a specified connection interface standard are received from a host system. A connection interface standard used by a connection interface unit of the memory storage device is adjusted from a first connection interface standard to the specified connection interface standard based on the switching command, in which the first connection interface standard is different from the specified connection interface standard.

An exemplary embodiment of the disclosure further provides a memory control circuit unit for controlling a memory storage device. The memory storage device includes a connection interface unit, the connection interface unit is configured to couple to a host system, and the memory control circuit unit includes a host interface, a memory interface and a memory management circuit. The host interface is configured to couple to the connection interface unit. The memory interface is configured to couple to a rewritable non-volatile memory module. The memory management circuit is coupled to the host interface and the memory interface, in which the memory management circuit is configured to perform the following operation. Device status information of the memory storage device is obtained, in which the device status information reflects whether the memory storage device is performing a default operation. A connection interface standard used by a connection interface unit of the memory storage device is adjusted from a first connection interface standard to a second connection interface standard according to the device status information, in which the first connection interface standard is different from the second connection interface standard.

In an exemplary embodiment of the disclosure, adjusting the connection interface standard used by the connection interface unit of the memory storage device from the first connection interface standard to the second connection interface standard by the memory management circuit includes the following operation. In response to the memory storage device performing the default operation, an expected data transfer volume per unit time is generated between the memory storage device and the host system. The connection interface standard used by the connection interface unit of the memory storage device is adjusted from the first connection interface standard to the second connection interface standard according to the expected data transfer volume per unit time.

In an exemplary embodiment of the disclosure, generating the expected data transfer volume per unit time between the memory storage device and the host system by the memory management circuit includes the following operation. The expected data transfer volume per unit time corresponding to the default operation is obtained from a comparison table.

In an exemplary embodiment of the disclosure, the device status information further includes a current transfer rate of the memory storage device, and generating the expected data transfer volume per unit time between the memory storage device and the host system by the memory management circuit includes the following operation. The expected data transfer volume per unit time is obtained according to the current transfer rate based on the default operation.

In an exemplary embodiment of the disclosure, the memory management circuit is further configured to perform the following operation. In response to completing the default operation, the connection interface standard used by the connection interface unit is restored from the second connection interface standard to the first connection interface standard.

In an exemplary embodiment of the disclosure, the memory management circuit is further configured to perform the following operation. In response to completing the default operation, the connection interface standard used by the connection interface unit is adjusted from the second connection interface standard to a third connection interface standard according to a current temperature of the memory storage device and/or a number of pending commands. The third connection interface standard is different from the first connection interface standard and the second connection interface standard.

In an exemplary embodiment of the disclosure, the memory management circuit is further configured to perform the following operation. A power status protocol is received from the host system. The power status protocol includes a default condition for adjusting the connection interface standard used by the connection interface unit and a specified connection interface standard corresponding to the default condition. In response to the default condition being met, the connection interface standard used by the connection interface unit is adjusted from the first connection interface standard to the specified connection interface standard, in which the first connection interface standard is different from the specified connection interface standard.

In an exemplary embodiment of the disclosure, the memory management circuit is further configured to perform the following operation. A switching command and a specified connection interface standard are received from a host system. A connection interface standard used by a connection interface unit of the memory storage device is adjusted from a first connection interface standard to the specified connection interface standard based on the switching command, in which the first connection interface standard is different from the specified connection interface standard.

Based on the above, the device control method, memory storage device and memory control circuit unit of the disclosure adjust the connection interface standard used by the connection interface unit of the memory storage device according to the device status information that reflects whether the memory storage device is performing a default operation, so as to improve the energy conversion rate of the memory storage device.

### BRIEF DESCRIPTION OF THE DRAWINGS

FIG. 1 is a schematic diagram of a host system, a memory storage device, and an input/output (I/O) device according to an exemplary embodiment of the disclosure.

FIG. 2 is a schematic diagram of a host system, a memory storage device, and an I/O device according to an exemplary embodiment of the disclosure.

FIG. 3 is a schematic diagram of a host system and a memory storage device according to an exemplary embodiment of the disclosure.

FIG. 4 is a schematic block diagram of a memory storage device according to an exemplary embodiment of the disclosure.

FIG. 5 is a schematic block diagram of a memory control circuit unit according to an exemplary embodiment of the disclosure.

FIG. 6 is a schematic diagram of managing a rewritable non-volatile memory module according to an exemplary embodiment of the disclosure.

FIG. 7 is a schematic diagram of the rate upper limit and the maximum transfer rate of various connection interface standards according to an exemplary embodiment of the disclosure.

FIG. 8 is a flowchart of a device control method according to an exemplary embodiment of the disclosure.

FIG. 9 is a flowchart of a device control method according to an exemplary embodiment of the disclosure.

FIG. 10 is a flowchart of a device control method according to an exemplary embodiment of the disclosure.

FIG. 11 is a flowchart of a device control method according to an exemplary embodiment of the disclosure.

### DETAILED DESCRIPTION OF DISCLOSED EMBODIMENTS

In general, a memory storage device (also referred to as a memory storage system) includes a rewritable non-volatile memory module and a controller (also referred to as a control circuit). The memory storage device can be used with a host system so that the host system can write data to or read data from the memory storage device.

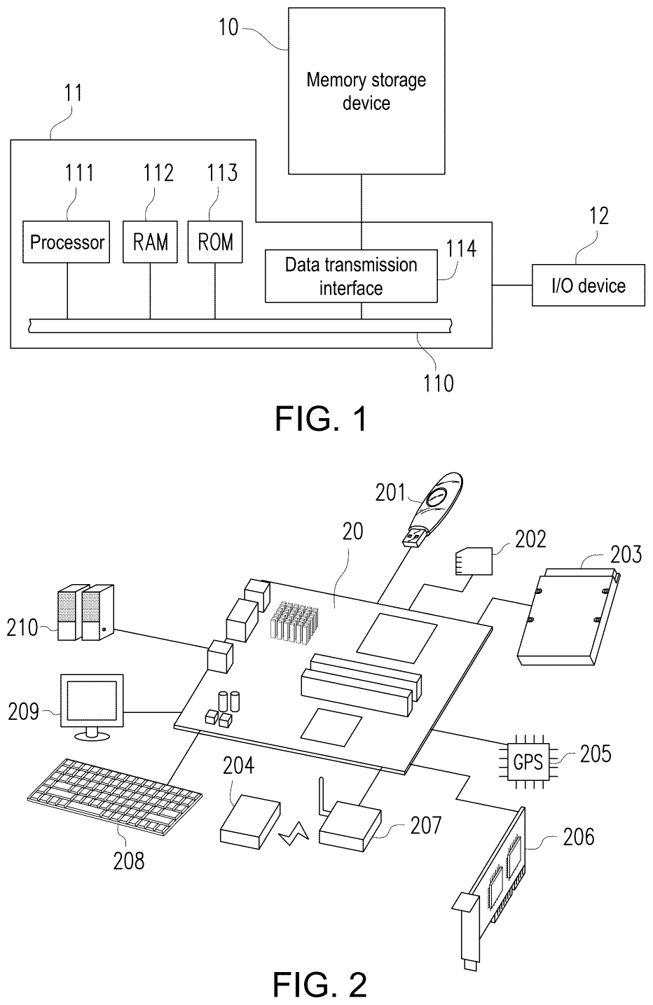

FIG. 1 is a schematic diagram of a host system, a memory storage device, and an input/output (I/O) device according to an exemplary embodiment of the disclosure. FIG. 2 is a schematic diagram of a host system, a memory storage device, and an I/O device according to an exemplary embodiment of the disclosure.

Referring to FIG. 1 and FIG. 2, a host system 11 may include a processor 111, a random access memory (RAM) 112, a read only memory (ROM) 113, and a data transmission interface 114. The processor 111, the random access memory 112, the read only memory 113, and the data transmission interface 114 may be coupled to a system bus 110.

In an exemplary embodiment, the host system 11 may be coupled to a memory storage device 10 through the data transfer interface 114. For example, the host system 11 may store data to or read data from the memory storage device 10 via the data transmission interface 114. In addition, the host system 11 may be coupled to an I/O device 12 through the system bus 110. For example, the host system 11 may transmit output signals to or receive input signals from the I/O device 12 via the system bus 110.

In an exemplary embodiment, the processor 111, the random access memory 112, the read only memory 113, and the data transmission interface 114 may be disposed on a motherboard 20 of the host system 11. The number of the data transmission interface 114 may be one or more. The motherboard 20 may be coupled to the memory storage device 10 through the data transmission interface 114 via a wired or wireless connection.

In an exemplary embodiment, the memory storage device 10 may be, for example, a flash drive 201, a memory card 202, a solid state drive (SSD) 203, or a wireless memory storage device 204. The wireless memory storage device 204 may be a memory storage device based on various wireless communication technologies, such as a near field communication (NFC) memory storage device, a wireless fax (WiFi) memory storage device, a Bluetooth memory storage device, a low power Bluetooth memory storage device (e.g. iBeacon), etc. In addition, the motherboard 20 may also be coupled to various I/O devices, such as a global positioning system (GPS) module 205, a network interface card 206, a wireless transmission device 207, a keyboard 208, a screen 209, a speaker 210, etc., through the system bus 110. For example, in an exemplary embodiment, the motherboard 20 may access the wireless memory storage device 204 through the wireless transmission device 207.

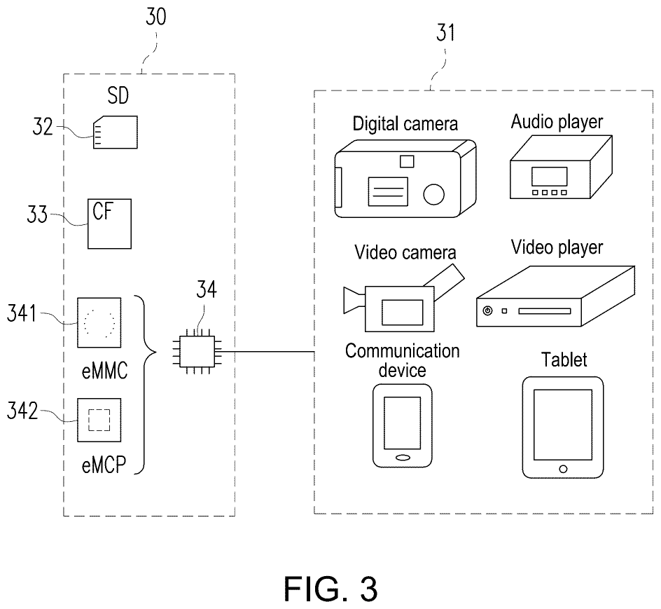

In an exemplary embodiment, the host system 11 is a computer system. In an exemplary embodiment, the host system 11 can be any system that can substantially cooperate with a memory storage device to store data. In an exemplary embodiment, the memory storage device 10 and the host system 11 may respectively include the memory storage device 30 and the host system 31 of FIG. 3.

FIG. 3 is a schematic diagram of a host system and a memory storage device according to an exemplary embodiment of the disclosure. Referring to FIG. 3, the memory storage device 30 can be used in conjunction with the host system 31 to store data. For example, the host system 31 may be a system such a digital camera, a video camera, a communication device, an audio player, a video player, or a tablet, etc. For example, the memory storage device 30 can be various non-volatile memory storage devices, such as a secure digital (SD) card 32, a compact flash (CF) card 33, or an embedded storage device 34, etc., used in the host system 31. The embedded storage device 34 includes various embedded storage devices that directly couple a memory module to a substrate of the host system, such as an embedded multimedia card (eMMC) 341 and/or an embedded multi-chip package (eMCP) storage device 342, etc.

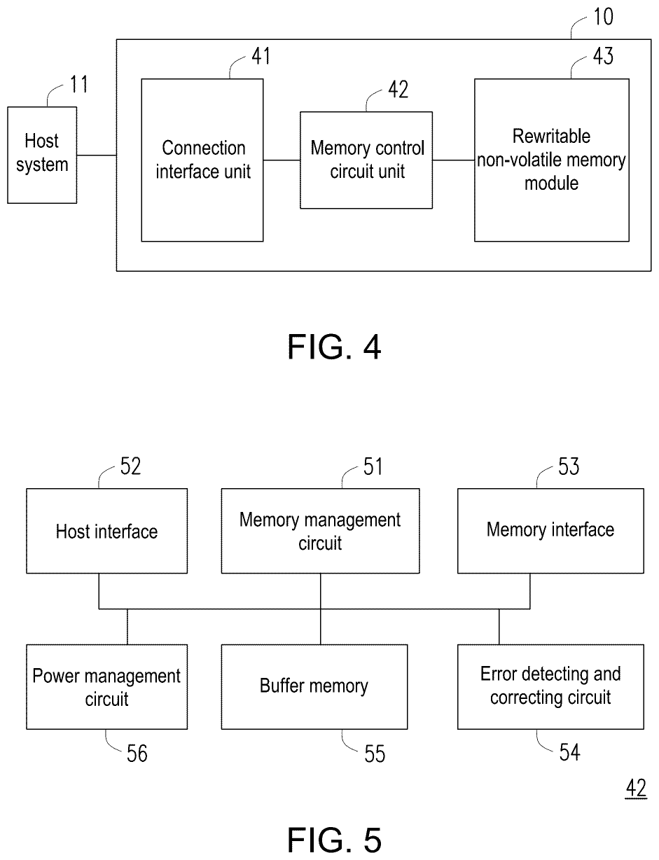

FIG. 4 is a schematic diagram of a memory storage device according to an exemplary embodiment of the disclosure. Referring to FIG. 4, the memory storage device 10 includes a connection interface unit 41, a memory control circuit unit 42, and a rewritable non-volatile memory module 43.

The connection interface unit 41 is configured to couple to a host system 11. The memory storage device 10 can communicate with the host system 11 via the connection interface unit 41. In an exemplary embodiment, the connection interface unit 41 is compatible with the peripheral component interconnect express (PCI Express) standard. In an exemplary embodiment, the connection interface unit 41 may also be compliant to the serial advanced technology attachment (SATA) standard, the parallel advanced technology attachment (PATA) standard, the institute of electrical and electronics engineers (IEEE) 1394 standard, the universal serial bus (USB) standard, the SD interface standard, the ultra high speed-I (UHS-I) interface standard, the ultra high speed-II (UHS-II) interface standard, the memory stick (MS) interface standard, the MCP interface standard, the MMC interface standard, the eMMC interface standard, the universal flash storage (UFS) interface standard, the eMCP interface standard, the CF interface standard, the integrated device electronics (IDE) standard, or other suitable standards. The connection interface unit 41 may be packaged in a chip with the memory control circuit unit 42, or the connection interface unit 41 may be disposed outside a chip including the memory control circuit unit 42.

The memory control circuit unit 42 is coupled to the connection interface unit 41 and the rewritable non-volatile memory module 43. The memory control circuit unit 42 is used to execute multiple logic gates or control commands implemented in a hardware form or a firmware form and to perform operations such as writing, reading, and erasing of data in the rewritable non-volatile memory module 43 according to the commands of the host system 11.

The rewritable non-volatile memory module 43 is used to store the data written by the host system 11. The rewritable non-volatile memory module 43 may include a single level cell (SLC) NAND-type flash memory module (i.e., a flash memory that can store 1 bit in one memory cell), multi-level cell (MLC) NAND-type flash memory module (i.e., a flash memory module that can store 2 bits in one memory cell), a triple level cell (TLC) NAND-type flash memory module (i.e., a flash memory module that can store 3 bits in one memory cell), a quad level cell (QLC) NAND-type flash memory module (i.e., a flash memory module that can store 4 bits in one memory cell), other flash memory modules, or other memory modules with the same characteristics.

Each memory cell in the rewritable non-volatile memory module 43 stores one or more bits by a change in a voltage (also referred to as a threshold voltage hereinafter). Specifically, there is a charge trapping layer between a control gate and a channel of each of the memory cells. By applying a write voltage to the control gate, the amount of electrons in the charge trapping layer can be changed, thereby changing the threshold voltage of the memory cell. This operation of changing the threshold voltage of the memory cell is also referred to as “writing data to the memory cell” or “programming the memory cell”. As the threshold voltage changes, each of the memory cells in the rewritable non-volatile memory module 43 has multiple storage statuses. By applying a read voltage, it is possible to determine which storage status a memory cell belongs to, thereby obtaining the one or more bits stored in the memory cell.

In an exemplary embodiment, the memory cells of the rewritable non-volatile memory module 43 may constitute multiple physical programming units, and the physical programming units may constitute multiple physical erasing units. Specifically, memory cells on the same word line can form one or more physical programming units. If each memory cell can store two or more bits, the physical programming units on the same word line may be classified at least as lower physical programming units and upper physical programming units. For example, the least significant bit (LSB) of a memory cell belongs to a lower physical programming unit, and the most significant bit (MSB) of a memory cell belongs to an upper physical programming unit. Generally, in an MLC NAND flash memory, the write speed of the lower physical programming unit is greater than the write speed of the upper physical programming unit, and/or the reliability of the lower physical programming unit is higher than the reliability of the upper physical programming unit.

In the present exemplary embodiment, the physical programming unit is the minimum unit for programming. That is, the physical programming unit is the minimum unit for write data. For example, the physical programming unit may be a physical page or a physical sector. If the physical programming unit is a physical page, then the physical programming unit may include a data bit area and a redundancy bit area. The data bit area includes multiple physical sectors is used for storing user data, and the redundant bit area is used for storing system data (e.g., management data such as error correction codes). In an exemplary embodiment, the data bit area includes 32 physical sectors, and the size of a physical sector is 512 bytes (B). However, in other exemplary embodiments, the data bit area may also include 8, 16, or a greater or lesser number of physical sectors, and the size of each of the physical sectors may also be larger or smaller. On the other hand, the physical erasing unit is the minimum unit for erasing. That is, each of the physical erasing units includes the smallest number of memory cells to be erased together. For example, the physical erasing unit is a physical block.

FIG. 5 is a schematic diagram of a memory control circuit unit according to an exemplary embodiment of the disclosure. Referring to FIG. 5, the memory control circuit unit 42 includes a memory management circuit 51, a host interface 52, and a memory interface 53.

The memory management circuit 51 is used to control the overall operation of the memory control circuit unit 42. Specifically, the memory management circuit 51 has multiple control commands, and when the memory storage device 10 operates, the control commands are executed to perform operations such as writing, reading, and erasing data. The following description of the operation of the memory management circuit 51 is equivalent to the description of the operation of the memory control circuit unit 42.

In an exemplary embodiment, the control commands of the memory management circuit 51 are implemented in a firmware form. For example, the memory management circuit 51 has a microprocessor unit (not shown) and a read only memory (not shown), and the control commands are programmed into the read only memory. When the memory storage device 10 operates, the control commands are executed by the microprocessor unit to perform operations such as writing, reading, and erasing data.

In an exemplary embodiment, the control commands of the memory management circuit 51 may also be stored in a specific area of the rewritable non-volatile memory module 43 (for example, a system area dedicated to storing system data in the memory module) in a program code form. In addition, the memory management circuit 51 has a microprocessor unit (not shown), a read-only memory (not shown), and a random access memory (not shown). In particular, the read only memory has a boot code, and when the memory control circuit unit 42 is enabled, the microprocessor unit first executes the boot code to load the control commands stored in the rewritable non-volatile memory module 43 into the random access memory of the memory management circuit 51. Thereafter, the microprocessor unit runs these control commands to perform operations such as writing, reading, and erasing data.

In an exemplary embodiment, the control commands of the memory management circuit 51 can also be implemented in a hardware form. For example, the memory management circuit 51 includes a microcontroller, a memory cell management circuit, a memory writing circuit, a memory reading circuit, a memory erasing circuit, and a data processing circuit. The memory cell management circuit, the memory writing circuit, the memory reading circuit, the memory erasing circuit, and the data processing circuit are coupled to the microcontroller. The memory cell management circuit is used to manage the memory cells or a memory cell group of the rewritable non-volatile memory module 43. The memory writing circuit is used to issue a write command sequence to the rewritable non-volatile memory module 43 to write data into the rewritable non-volatile memory module 43. The memory reading circuit is used to issue a read command sequence to the rewritable non-volatile memory module 43 to read data from the rewritable non-volatile memory module 43. The memory erasing circuit is used to issue an erase command sequence to the rewritable non-volatile memory module 43 to erase data from the rewritable non-volatile memory module 43. The data processing circuit is used to process the data to be written into the rewritable non-volatile memory module 43 and the data read from the rewritable non-volatile memory module 43. The write command sequence, the read command sequence and the erase command sequence can respectively include one or more program codes or command codes for instructing the rewritable non-volatile memory module 43 to perform corresponding writing, reading, and erasing operations. In an exemplary embodiment, the memory management circuit 51 may also issue other types of command sequences to the rewritable non-volatile memory module 43 to instruct the rewritable non-volatile memory module 43 to perform corresponding operations.

The host interface 52 is coupled to the memory management circuit 51. The memory management circuit 51 can communicate with the host system 11 through the host interface 52. The host interface 52 can be used to receive and identify the commands and data transmitted by the host system 11. For example, the commands and data transmitted by the host system 11 may be transmitted to the memory management circuit 51 through the host interface 52. In addition, the memory management circuit 51 can transmit data to the host system 11 through the host interface 52. In this exemplary embodiment, the host interface 52 is compatible with the PCI Express standard. However, it should be understood that the disclosure is not limited thereto, and the host interface 52 can also be compatible with the SATA standard, the PATA standard, the IEEE 1394 standard, the USB standard, the SD standard, the UHS-I standard, the UHS-II standard, the MS standard, the MMC standard, the eMMC standard, the UFS standard, the CF standard, the IDE standard, or other suitable data transfer standards.

The memory interface 53 is coupled to the memory management circuit 51 and is used to access the rewritable non-volatile memory module 43. For example, the memory management circuit 51 can access the rewritable non-volatile memory module 43 through the memory interface 53. In other words, the data to be written into the rewritable non-volatile memory module 43 is converted into a format acceptable to the rewritable non-volatile memory module 43 via the memory interface 53. Specifically, if the memory management circuit 51 is to access the rewritable non-volatile memory module 43, the memory interface 53 transmits a corresponding command sequence. For example, the command sequences may include a write command sequence to instruct data writing, a read command sequence to instruct data reading, an erase command sequence to instruct data erasing, and corresponding command sequences for instructing various memory operations (e.g., changing the read voltage level, executing a garbage collection (GC) operation, etc.). These command sequences are, for example, generated by the memory management circuit 51 and transmitted to the rewritable non-volatile memory module 43 via the memory interface 53. These command sequences may include one or more signals or data on the bus. The signals or data may include command codes or program codes. For example, the read command sequence includes information such as the read identification code, the memory address, etc.

In an exemplary embodiment, the memory control circuit unit 42 further includes an error detecting and correcting circuit 54, a buffer memory 55, and a power management circuit 56.

The error detecting and correcting circuit 54 is coupled to the memory management circuit 51 and is configured to execute an error detecting and correcting operation to ensure the correctness of the data. Specifically, when the memory management circuit 51 receives a write command from the host system 11, the error detecting and correcting circuit 54 generates a corresponding error correcting code (ECC) and/or error detecting code (EDC) for the data corresponding to the write command, and the memory management circuit 51 writes the data corresponding to the write command and the corresponding error correcting code and/or error detecting code to the rewritable non-volatile memory module 43. Thereafter, when the memory management circuit 51 reads data from the rewritable non-volatile memory module 43, it simultaneously reads the error correcting code and/or the error detecting code corresponding to the data, and the error detecting and correcting circuit 54 executes the error detecting and correcting operation on the read data according to the error correcting code and/or error detecting code.

The buffer memory 55 is coupled to the memory management circuit 51 and used to temporarily store data. The power management circuit 56 is coupled to the memory management circuit 51 and used to control the power of the memory storage device 10.

In an exemplary embodiment, the rewritable non-volatile memory module 43 of FIG. 4 may include a flash memory module. In an exemplary embodiment, the memory control circuit unit 42 of FIG. 4 may include a flash memory controller. In an exemplary embodiment, the memory management circuit 51 of FIG. 5 may include a flash memory management circuit.

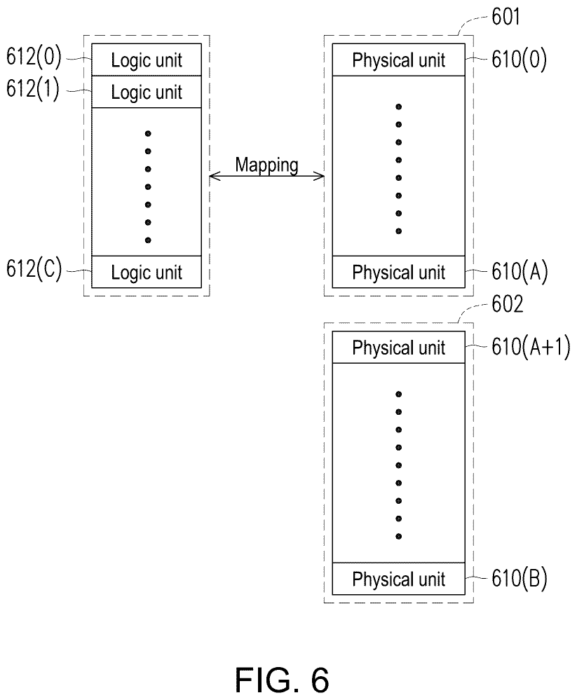

FIG. 6 is a schematic diagram of managing a rewritable non-volatile memory module according to an exemplary embodiment of the disclosure. Referring to FIG. 6, the memory management circuit 51 can logically group the physical units 610(0) to 610(B) in the rewritable non-volatile memory module 43 into a storage area 601 and a spare area 602.

In an exemplary embodiment, a physical unit refers to a physical address or a physical programming unit. In an exemplary embodiment, a physical unit may also be formed by multiple consecutive or non-consecutive physical addresses. In an exemplary embodiment, a physical unit may also refer to a virtual block (VB). A virtual block can include multiple physical addresses or multiple physical programming units. In an exemplary embodiment, a virtual block includes one or more physical erasing units.

The physical units 610(0) to 610(A) in the storage area 601 are used to store user data (e.g., user data from the host system 11 of FIG. 1). For example, the physical units 610(0) to 610(A) in the storage area 601 can store valid data and invalid data. The physical units 610(A+1) to 610(B) in the spare area 602 do not store data (e.g., valid data). For example, if a certain physical unit does not store valid data, this physical unit can be associated (or added) to the spare area 602. In addition, the physical units in the spare area 602 (or the physical units not storing valid data) can be erased. When new data is written, one or more physical units may be extracted from the spare area 602 to store the new data. In an exemplary embodiment, the spare area 602 is also referred to as a free pool.

The logic units 612(0) to 612(C) can be configured in the memory management circuit 51 to map the physical units 610(0) to 610(A) in the storage area 601. In an exemplary embodiment, each of the logical units corresponds to a logical address. For example, a logical address may include one or more logical block addresses (LBA) or other logical management units. In an exemplary embodiment, a logical unit may also correspond to a logical programming unit or be formed by multiple consecutive or non-consecutive logical addresses.

It should be noted that a logical unit can be mapped to one or more physical units. If a certain physical unit is currently mapped by a certain logical unit, it means that the data currently stored in this physical unit includes valid data. On the contrary, if a certain physical unit is not currently mapped by any logic unit, it means that the data currently stored in this physical unit is invalid data.

The memory management circuit 51 may record the management data (also referred to as the logical to physical mapping information) describing the mapping relationship between logical units and physical units in at least one logical to physical mapping table. When the host system 11 reads data from the memory storage device 10 or writes data to the memory storage device 10, the memory management circuit 51 can access the rewritable non-volatile memory module 43 according to the information in the logical to physical mapping table.

In an exemplary embodiment, the connection interface standards that the connection interface unit 41 can use may include at least two of the N generations of the PCI Express standards, in which N is a positive integer greater than 0. For example, the connection interface standards that the connection interface unit 41 can use may include at least two of the Gen 1, the Gen 2, the Gen 3, the Gen 4, and the Gen 5 of the PCI Express standards. Therefore, in an exemplary embodiment, the first connection interface standard may be one of PCI Express Gen 1, Gen 2, Gen 3, Gen 4 and Gen 5, and the second connection interface standard may be another one of PCI Express Gen 1, Gen 2, Gen 3, Gen 4 and Gen 5. In an exemplary embodiment, the connection interface unit 41 may also use other types of connection interface standards, which are not limited by the disclosure.

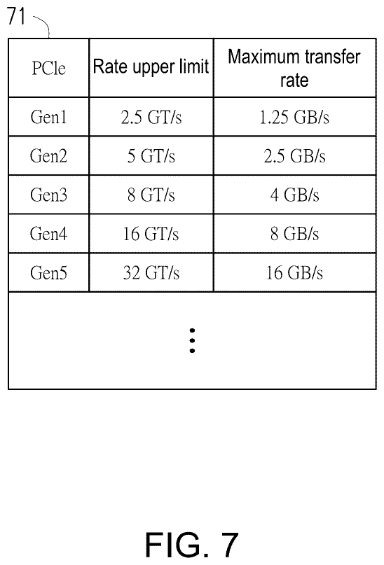

FIG. 7 is a schematic diagram of the rate upper limit and the maximum transfer rate of various connection interface standards according to an exemplary embodiment of the disclosure. Referring to FIG. 7, in an exemplary embodiment, the table 71 records the rate upper limit and the maximum transfer rate of various connection interface standards that the connection interface unit 41 can use. For example, the information in the table 71 may present the data transfer volume per unit time upper limit and the maximum transfer rate of the memory storage device 10 (or the connection interface unit 41) under different connection interface standards. In an exemplary embodiment, the data transfer volume per unit time upper limit is also referred to as the transfer rate upper limit. In an exemplary embodiment, the data transfer volume per unit time upper limit may reflect the maximum value of the allowed data transfer volume per unit time between the memory storage device 10 and the host system 11.

For example, when the connection interface standard used by the connection interface unit 41 is PCIE Gen 1, the data transfer volume per unit time upper limit of the connection interface unit 41 is 2.5 GT/s (Gigatransfer per second). When the connection interface standard used by the connection interface unit 41 is PCIE Gen 2, the data transfer volume per unit time upper limit of the connection interface unit 41 is 5 GT/s. When the connection interface standard used by the connection interface unit 41 is PCIE Gen 3, the data transfer volume per unit time upper limit of the connection interface unit 41 is 8 GT/s. When the connection interface standard used by the connection interface unit 41 is PCIE Gen 4, the data transfer volume per unit time upper limit of the connection interface unit 41 is 16 GT/s. When the connection interface standard used by the connection interface unit 41 is PCIE Gen 5, the data transfer volume per unit time upper limit of the connection interface unit 41 is 32 GT/s.

For example, the connection interface unit 41 has 4 lanes. When the connection interface standard used by the connection interface unit 41 is PCIE Gen 1, the maximum transfer rate of the connection interface unit 41 is “(2.5 GT/s)×(4 Lane)÷(8 Byte/T)=1.25 GB/s”. When the connection interface standard used by the connection interface unit 41 is PCIE Gen 2, the maximum transfer rate of the connection interface unit 41 is 2.5 GB/s. When the connection interface standard used by the connection interface unit 41 is PCIE Gen 3, the maximum transfer rate of the connection interface unit 41 is 4 GB/s. When the connection interface standard used by the connection interface unit 41 is PCIE Gen 4, the maximum transfer rate of the connection interface unit 41 is 8 GB/s. When the connection interface standard used by the connection interface unit 41 is PCIE Gen 5, the maximum transfer rate of the connection interface unit 41 is 16 GB/s. However, in an exemplary embodiment, all information in the table 71 can be adjusted according to practical requirements, which is not limited by the disclosure.

In an exemplary embodiment, the memory management circuit 51 can obtain device status information of the memory storage device 10. This device status information reflects whether the memory storage device 10 is performing a default operation. For example, during the period when the memory storage device 10 performs the default operation, the memory storage device 10 is in a busy state, resulting in a reduction in the data transfer volume per unit time between the memory storage device 10 and the host system 11. For example, during the period when the memory storage device 10 performs the default operation, the data transfer volume per unit time of the memory storage device 10 may be affected by the default operation. For example, the default operation may include but is not limited to at least one of a garbage collection operation, a wear leveling (WL) operation, a device self-test (DST) operation, and an error handle operation.

In an exemplary embodiment, a garbage collection operation may be used to copy valid data from a certain physical unit (also referred to as a source unit) in the rewritable non-volatile memory module 43 to another physical unit (also referred to as a target unit) to release new spare physical units. For example, the released spare physical units may be added to the spare area 602 of FIG. 6 to increase the total number of physical units in the spare area 602.

In an exemplary embodiment, the wear leveling operation is also used to copy valid data from a certain physical unit (i.e., the source unit) in the rewritable non-volatile memory module 43 to another physical unit (i.e., the target unit). However, what is different from the garbage collection operation is that the wear-leveling operation is used to wear-balance multiple physical units with different levels of wear in the rewritable non-volatile memory module 43. For example, the wear leveling may refer to the balance of the number of programming times, erasing times, and/or reading times among multiple physical units.

In an exemplary embodiment, the device self-test operation may be used to perform a large number of read operations or various test algorithms on the rewritable non-volatile memory module 43 to check the health status of the memory storage device 10. For example, the device self-test operation may be triggered by the host system 11 or triggered by the memory storage device 10 according to specific conditions.

In an exemplary embodiment, the error handle operation can be used to perform an error handling mechanism on the channel or address corresponding to the command after a command fails (e.g., a read failure, an erase failure, or a write failure) to avoid the recurrence of failed commands.

In an exemplary embodiment, the memory management circuit 51 can adjust the connection interface standard used by the connection interface unit 41 according to the device status information. For example, the memory management circuit 51 can adjust the connection interface standard used by the connection interface unit 41 from a certain connection interface standard (also referred to as a first connection interface standard) to another connection interface standard (also referred to as a first connection interface standard) according to the device status information. The first connection interface standard is different from the second connection interface standard.

In an exemplary embodiment, in response to the connection interface unit 41 using the first connection interface standard, the memory storage device 10 may have a specific data transfer volume per unit time upper limit (also referred to as the first data transfer volume per unit time upper limit). In response to the connection interface unit 41 using the second connection interface standard, the memory storage device 10 may have another data transfer volume per unit time upper limit (also referred to as the second data transfer volume per unit time upper limit). The first data transfer volume per unit time upper limit is different from the second data transfer volume per unit time upper limit. For example, the first data transfer volume per unit time upper limit may be higher or lower than the second data transfer volume per unit time upper limit.

In an exemplary embodiment, during the period when the memory storage device 10 performs the default operation, the data transfer volume per unit time of the memory storage device 10 may be reduced due to the influence of the default operation. At this time, even though the connection interface standard (e.g., PCIE Gen 5) currently used by the connection interface unit 41 can have a higher data transfer rate upper limit, the actual data transfer volume per unit time of the memory storage device 10 often cannot reach the expected maximum data transfer rate due to the influence of the default operation.

In an exemplary embodiment, the memory management circuit 51 can determine whether the memory storage device 10 is performing the default operation according to the device status information. If the memory storage device 10 is performing the default operation, the memory management circuit 51 can generate an expected data transfer volume per unit time between the memory storage device 10 and the host system 11, and adjust the connection interface standard used by the connection interface unit 41 from the first connection interface standard to the second connection interface standard according to the expected data transfer volume per unit time to improve the energy conversion rate of the memory storage device 10.

In an exemplary embodiment, the memory management circuit 51 may generate the expected data transfer volume per unit time by looking up a table. For example, the memory management circuit 51 may record the maximum transfer rate corresponding to each default operation in a comparison table. Then, the memory management circuit 51 can obtain the maximum transfer rate (e.g., 6 GB/s) corresponding to the default operation from the comparison table, and determine that the maximum transfer rate of 6 GB/s is between the maximum transfer rate of 4 GB/s of PCIE Gen 3 and the maximum transfer rate of 8 GB/s of PCIE Gen 4. Accordingly, the memory management circuit 51 can determine that the expected data transfer volume per unit time when performing the default operation is 16 GT/s corresponding to PCIE Gen 4. Next, the memory management circuit 51 can adjust the connection interface standard used by the connection interface unit 41 from PCIE Gen 5 to PCIE Gen 4 to improve the energy conversion rate of the memory storage device 10.

In an exemplary embodiment, the device status information includes but is not limited to the current transfer rate of the memory storage device 10. The memory management circuit 51 may obtain the expected data transfer volume per unit time according to the current transfer rate based on the default operation. For example, under the condition of performing the aforementioned default operation at the current transfer rate (e.g., 5.5 GB/s), the memory management circuit 51 uses the current transfer rate as a reference to estimate the maximum transfer rate (e.g., 6 GB/s) under the same condition, and determines that the maximum transfer rate of 6 GB/s is between the maximum transfer rate of 4 GB/s of PCIE Gen 3 and the maximum transfer rate of 8 GB/s of PCIE Gen 4. Accordingly, the memory management circuit 51 can determine that the expected data transfer volume per unit time when performing the default operation is 16 GT/s corresponding to PCIE Gen 4. Then, the memory management circuit 51 can adjust the connection interface standard used by the connection interface unit 41 from PCIE Gen 5 to PCIE Gen 4 to improve the energy conversion rate of the memory storage device 10.

In an exemplary embodiment, after the default operation is completed, the memory management circuit 51 may restore the connection interface standard used by the connection interface unit 41 to the previous connection interface standard. For example, the memory management circuit 51 can restore the connection interface standard used by the connection interface unit 41 from PCIE Gen 4 to PCIE Gen 5 to avoid reducing the performance per watt of the memory storage device 10.

In an exemplary embodiment, after the default operation is completed, the memory management circuit 51 may adjust the connection interface standard used by the connection interface unit 41 (i.e., the second connection interface standard) to another connection interface standard (also referred to the third connection interface standard). For example, the memory management circuit 51 may adjust the connection interface standard used by the connection interface unit 41 from PCIE Gen 4 to a third connection interface standard (e.g., PCIE Gen 3) according to the current temperature of the memory storage device 10 and/or the number of pending commands to avoid reducing the performance per watt of the memory storage device 10. The third connection interface standard is different from the first connection interface standard and the second connection interface standard. That is, the data transfer volume per unit time upper limit of the third connection interface standard is different from the data transfer volume per unit time upper limit of the first connection interface standard and the data transfer volume per unit time upper limit of the second connection interface standard. For example, the data transfer volume per unit time upper limit of the third connection interface standard may be higher or lower than the data transfer volume per unit time upper limit of the first connection interface standard and the data transfer volume per unit time upper limit of the second connection interface standard.

In an exemplary embodiment, the connection interface standard used by the connection interface unit 41 can also be set by the user. For example, the memory management circuit 51 may receive a switching command and a specified connection interface standard (e.g., PCIE Gen 2) from the host system 11. Then, the memory management circuit 51 can adjust the connection interface standard used by the connection interface unit 41 from the first connection interface standard PCIE Gen 5 to the specified connection interface standard PCIE Gen 2 in response to the switching command. The data transfer volume per unit time upper limit of the first connection interface standard is different from the data transfer volume per unit time upper limit of the specified connection interface standard. For example, the data transfer volume per unit time upper limit of the first connection interface standard may be higher or lower than the data transfer volume per unit time upper limit of the specified connection interface standard.

In an exemplary embodiment, the adjustment method of the connection interface standard used by the connection interface unit 41 can also be preset by the user. For example, the memory management circuit 51 may receive a power status protocol from the host system 11. For example, the power status protocol includes a default condition for adjusting the connection interface standard used by the connection interface unit 41 and a specified connection interface standard corresponding to the default condition (e.g., PCIE Gen 2). For example, when a default condition in the power status protocol is met, the memory management circuit 51 can adjust the connection interface standard used by the connection interface unit 41 from the first connection interface standard PCIE Gen 5 to the specified connection interface standard PCIE Gen 2. Then, when another default condition in the power status protocol is met, the memory management circuit 51 can adjust the connection interface standard used by the connection interface unit 41 from PCIE Gen 2 to another connection interface standard (e.g., PCIE Gen 1).

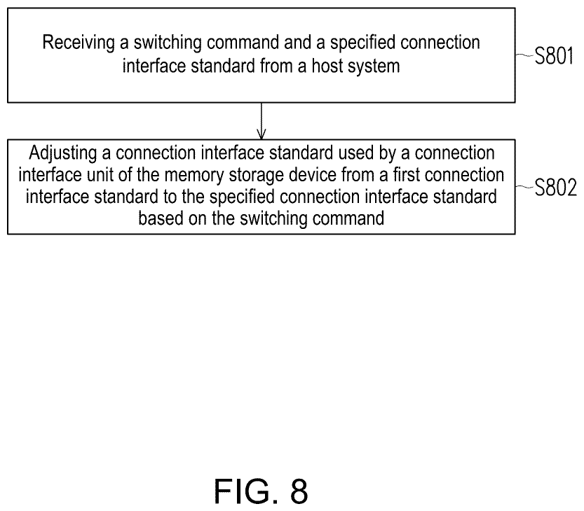

FIG. 8 is a flowchart of a device control method according to an exemplary embodiment of the disclosure. Referring to FIG. 8, in step S801, a switching command and a specified connection interface standard are received from the host system. In step S802, the connection interface standard used by a connection interface unit is adjusted from the first connection interface standard to the specified connection interface standard based on the switching command.

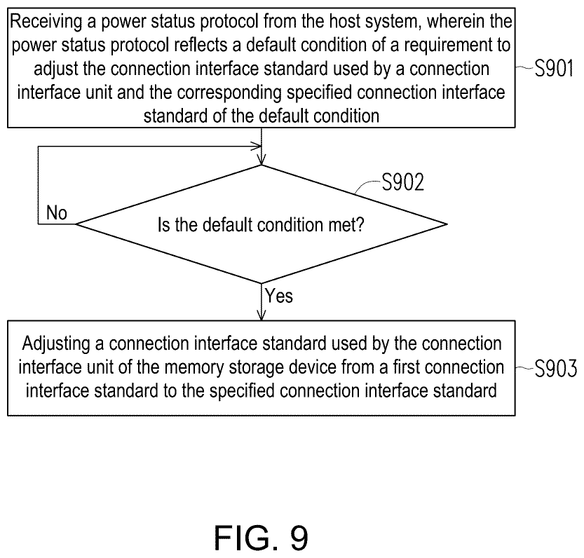

FIG. 9 is a flowchart of a device control method according to an exemplary embodiment of the disclosure. Referring to FIG. 9, in step S901, a power status protocol is received from the host system, in which the power status protocol reflects a default condition of a requirement to adjust the connection interface standard used by a connection interface unit and the corresponding specified connection interface standard of the default condition. In step S902, it is determined whether the default condition is met. If the default condition is not met, step S902 is repeated; otherwise, if the default condition is met, step S903 is proceeded. In step S903, the connection interface standard used by the connection interface unit is adjusted from the first connection interface standard to the specified connection interface standard.

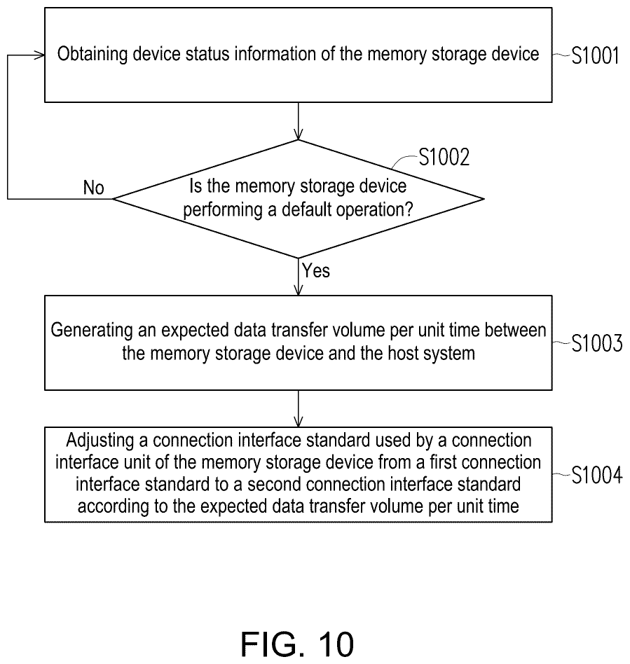

FIG. 10 is a flowchart of a device control method according to an exemplary embodiment of the disclosure. Referring to FIG. 10, in step S1001, device status information of the memory storage device is obtained. In step S1002, it is determined whether the memory storage device is performing a default operation. If the memory storage device is not performing the default operation, step S1001 is repeated; otherwise, if the memory storage device is performing the default operation, step S1003 is proceeded. In step S1003, an expected data transfer volume per unit time between the memory storage device and the host system is generated. In step S1004, the connection interface standard used by the connection interface unit is adjusted from the first connection interface standard to the second connection interface standard according to the expected data transfer volume per unit time.

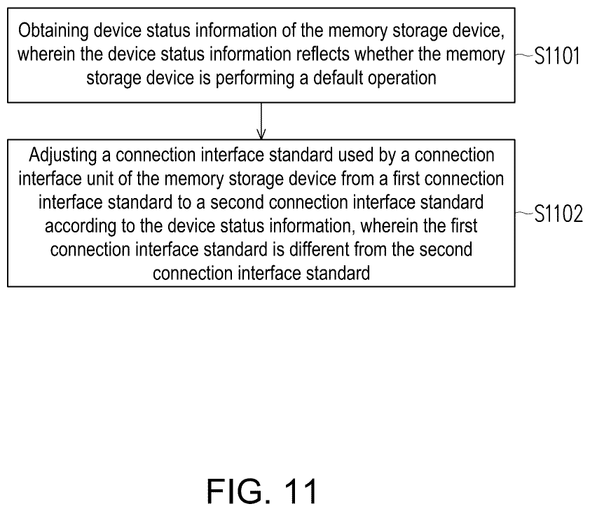

FIG. 11 is a flowchart of a device control method according to an exemplary embodiment of the disclosure. Referring to FIG. 11, in step S1101, device status information of the memory storage device is obtained, in which the device status information reflects whether the memory storage device is performing a default operation. In step S1102, the connection interface standard used by the connection interface unit is adjusted from the first connection interface standard to the second connection interface standard according to the device status information, in which the first connection interface standard is different from the second connection interface standard.

Each step in FIG. 8 to FIG. 11 has been described in detail as the above, and are not repeated herein. It is worth noting that each step in FIG. 8 to FIG. 11 can be implemented as multiple program codes or circuits, and the disclosure is not limited thereto. In addition, the methods of FIG. 8 to FIG. 11 can be used in conjunction with the above exemplary embodiments, or can also be used alone, which is not limited by the disclosure.

To sum up, the device control method, memory storage device and memory control circuit unit of the disclosure adjust the connection interface standard used by the connection interface unit of the memory storage device according to the device status information that reflects whether the memory storage device is performing a default operation, so as to improve the energy conversion rate of the memory storage device.

Although the disclosure has been described in detail with reference to the above embodiments, they are not intended to limit the disclosure. Those skilled in the art should understand that it is possible to make changes and modifications without departing from the spirit and scope of the disclosure. Therefore, the protection scope of the disclosure shall be defined by the following claims.

1. A device control method for a memory storage device, wherein the memory storage device comprises a connection interface unit, the connection interface unit is configured to couple to a host system, and the device control method comprises:
obtaining device status information of the memory storage device, wherein the device status information reflects whether the memory storage device is performing a default operation; and
adjusting a connection interface standard used by the connection interface unit from a first connection interface standard to a second connection interface standard according to the device status information, wherein the first connection interface standard is different from the second connection interface standard.

2. The device control method according to claim 1, wherein the default operation comprises at least one of a garbage collection operation, a wear leveling operation, a device self-test operation, and an error handle operation.

3. The device control method according to claim 1, wherein adjusting the connection interface standard used by the connection interface unit from the first connection interface standard to the second connection interface standard comprises:
in response to the memory storage device performing the default operation, generating an expected data transfer volume per unit time between the memory storage device and the host system; and
adjusting the connection interface standard used by the connection interface unit from the first connection interface standard to the second connection interface standard according to the expected data transfer volume per unit time.

4. The device control method according to claim 3, wherein generating the expected data transfer volume per unit time between the memory storage device and the host system comprises:
obtaining the expected data transfer volume per unit time corresponding to the default operation from a comparison table.

5. The device control method according to claim 3, wherein the device status information further comprises a current transfer rate of the memory storage device, and generating the expected data transfer volume per unit time between the memory storage device and the host system comprises:
obtaining the expected data transfer volume per unit time according to the current transfer rate based on the default operation.

6. The device control method according to claim 3, further comprising:
in response to completing the default operation, restoring the connection interface standard used by the connection interface unit from the second connection interface standard to the first connection interface standard.

7. The device control method according to claim 3, further comprising:
in response to completing the default operation, adjusting the connection interface standard used by the connection interface unit from the second connection interface standard to a third connection interface standard according to a current temperature of the memory storage device or a number of pending commands, wherein the third connection interface standard is different from the first connection interface standard and the second connection interface standard.

8. The device control method according to claim 1, further comprising:
receiving a power status protocol from the host system, wherein the power status protocol comprises a default condition for adjusting the connection interface standard used by the connection interface unit and a specified connection interface standard corresponding to the default condition; and
in response to the default condition being met, adjusting the connection interface standard used by the connection interface unit from the first connection interface standard to the specified connection interface standard, wherein the first connection interface standard is different from the specified connection interface standard.

9. The device control method according to claim 1, further comprising:
receiving a switching command and a specified connection interface standard from the host system; and
adjusting the connection interface standard used by the connection interface unit from the first connection interface standard to the specified connection interface standard based on the switching command, wherein the first connection interface standard is different from the specified connection interface standard.

10. The device control method according to claim 1, wherein the connection interface standard used by the connection interface unit comprises at least two of N generations of PCI Express standards, wherein N is a positive integer greater than 0.

11. The device control method according to claim 1, wherein in response to the connection interface unit using the first connection interface standard, the memory storage device has a first data transfer volume per unit time upper limit,
in response to the connection interface unit using the second connection interface standard, the memory storage device has a second data transfer volume per unit time upper limit, wherein the first data transfer volume per unit time upper limit is different from the second data transfer volume per unit time upper limit.

12. A memory storage device, comprising:
a connection interface unit, configured to couple to a host system;
a rewritable non-volatile memory module;
a memory control circuit unit, coupled to the connection interface unit and the rewritable non-volatile memory module,
wherein the memory control circuit unit is configured to:
obtain device status information of the memory storage device, wherein the device status information reflects whether the memory storage device is performing a default operation; and
adjust a connection interface standard used by the connection interface unit from a first connection interface standard to a second connection interface standard according to the device status information, wherein the first connection interface standard is different from the second connection interface standard.

13. The memory storage device according to claim 12, wherein the default operation comprises at least one of a garbage collection operation, a wear leveling operation, a device self-test operation, and an error handle operation.

14. The memory storage device according to claim 12, wherein adjusting the connection interface standard used by the connection interface unit from the first connection interface standard to the second connection interface standard by the memory control circuit unit comprises:
in response to the memory storage device performing the default operation, generating an expected data transfer volume per unit time between the memory storage device and the host system; and
adjusting the connection interface standard used by the connection interface unit from the first connection interface standard to the second connection interface standard according to the expected data transfer volume per unit time.

15. The memory storage device according to claim 14, wherein generating the expected data transfer volume per unit time between the memory storage device and the host system by the memory control circuit unit comprises:
obtaining the expected data transfer volume per unit time corresponding to the default operation from a comparison table.

16. The memory storage device according to claim 14, wherein the device status information further comprises a current transfer rate of the memory storage device, and generating the expected data transfer volume per unit time between the memory storage device and the host system by the memory control circuit unit comprises:
obtaining the expected data transfer volume per unit time according to the current transfer rate based on the default operation.

17. The memory storage device according to claim 14, wherein the memory control circuit unit is further configured to:
in response to completing the default operation, restore the connection interface standard used by the connection interface unit from the second connection interface standard to the first connection interface standard.

18. The memory storage device according to claim 14, wherein the memory control circuit unit is further configured to:
in response to completing the default operation, adjust the connection interface standard used by the connection interface unit from the second connection interface standard to a third connection interface standard according to a current temperature of the memory storage device or a number of pending commands, wherein the third connection interface standard is different from the first connection interface standard and the second connection interface standard.

19. The memory storage device according to claim 12, wherein the memory control circuit unit is further configured to:
receive a power status protocol from the host system, wherein the power status protocol comprises a default condition for adjusting the connection interface standard used by the connection interface unit and a specified connection interface standard corresponding to the default condition; and
in response to the default condition being met, adjust the connection interface standard used by the connection interface unit from the first connection interface standard to the specified connection interface standard, wherein the first connection interface standard is different from the specified connection interface standard.

20. The memory storage device according to claim 12, wherein the memory control circuit unit is further configured to:
receive a switching command and a specified connection interface standard from the host system; and
adjust the connection interface standard used by the connection interface unit from the first connection interface standard to the specified connection interface standard based on the switching command, wherein the first connection interface standard is different from the specified connection interface standard.

21. The memory storage device according to claim 12, wherein the connection interface standard used by the connection interface unit comprises at least two of N generations of PCI Express standards, wherein N is a positive integer greater than 0.

22. The memory storage device according to claim 12, wherein in response to the connection interface unit using the first connection interface standard, the memory storage device has a first data transfer volume per unit time upper limit,
in response to the connection interface unit using the second connection interface standard, the memory storage device has a second data transfer volume per unit time upper limit, wherein the first data transfer volume per unit time upper limit is different from the second data transfer volume per unit time upper limit.

23. A memory control circuit unit, for controlling a memory storage device, wherein the memory storage device comprises a connection interface unit, the connection interface unit is configured to couple to a host system, and the memory control circuit unit comprises:
a host interface, configured to couple to the connection interface unit;
a memory interface, configured to couple to a rewritable non-volatile memory module; and
a memory management circuit, coupled to the host interface and the memory interface,
wherein the memory management circuit is configured to:
obtain device status information of the memory storage device, wherein the device status information reflects whether the memory storage device is performing a default operation; and
adjust a connection interface standard used by the connection interface unit from a first connection interface standard to a second connection interface standard according to the device status information, wherein the first connection interface standard is different from the second connection interface standard.

24. The memory control circuit unit according to claim 23, wherein the default operation comprises at least one of a garbage collection operation, a wear leveling operation, a device self-test operation, and an error handle operation.

25. The memory control circuit unit according to claim 23, wherein adjusting the connection interface standard used by the connection interface unit from the first connection interface standard to the second connection interface standard by the memory management circuit comprises:
in response to the memory storage device performing the default operation, generating an expected data transfer volume per unit time between the memory storage device and the host system; and
adjusting the connection interface standard used by the connection interface unit from the first connection interface standard to the second connection interface standard according to the expected data transfer volume per unit time.

26. The memory control circuit unit according to claim 25, wherein generating the expected data transfer volume per unit time between the memory storage device and the host system by the memory management circuit comprises:
obtaining the expected data transfer volume per unit time corresponding to the default operation from a comparison table.

27. The memory control circuit unit according to claim 25, wherein the device status information further comprises a current transfer rate of the memory storage device, and generating the expected data transfer volume per unit time between the memory storage device and the host system by the memory management circuit comprises:
obtaining the expected data transfer volume per unit time according to the current transfer rate based on the default operation.

28. The memory control circuit unit according to claim 25, wherein the memory management circuit is further configured to:
in response to completing the default operation, restore the connection interface standard used by the connection interface unit from the second connection interface standard to the first connection interface standard.

29. The memory control circuit unit according to claim 25, wherein the memory management circuit is further configured to:
in response to completing the default operation, adjust the connection interface standard used by the connection interface unit from the second connection interface standard to a third connection interface standard according to a current temperature of the memory storage device or a number of pending commands, wherein the third connection interface standard is different from the first connection interface standard and the second connection interface standard.

30. The memory control circuit unit according to claim 23, wherein the memory management circuit is further configured to:
receive a power status protocol from the host system, wherein the power status protocol comprises a default condition for adjusting the connection interface standard used by the connection interface unit and a specified connection interface standard corresponding to the default condition; and
in response to the default condition being met, adjust the connection interface standard used by the connection interface unit from the first connection interface standard to the specified connection interface standard, wherein the first connection interface standard is different from the specified connection interface standard.

31. The memory control circuit unit according to claim 23, wherein the memory management circuit is further configured to:
receive a switching command and a specified connection interface standard from the host system; and
adjust the connection interface standard used by the connection interface unit from the first connection interface standard to the specified connection interface standard based on the switching command, wherein the first connection interface standard is different from the specified connection interface standard.

32. The memory control circuit unit according to claim 23, wherein the connection interface standard used by the connection interface unit comprises at least two of N generations of PCI Express standards, wherein N is a positive integer greater than 0.

33. The memory control circuit unit according to claim 23, wherein in response to the connection interface unit using the first connection interface standard, the memory storage device has a first data transfer volume per unit time upper limit,
in response to the connection interface unit using the second connection interface standard, the memory storage device has a second data transfer volume per unit time upper limit, wherein the first data transfer volume per unit time upper limit is different from the second data transfer volume per unit time upper limit.
